(19) United States
(12) Patent Application Publication
(10) Pub. No.: US 2017/0169349 A1
(43) Pub. Date: Jun. 15, 2017

(54) RECOMMENDING METHOD AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Li Qi, Beijing (CN)

(21) Appl. No.: 15/248,497

(22) Filed: Aug. 26, 2016

Related U.S. Application Data
(63) Continuation of application No. PCT/CN2016/089244, filed on Jul. 7, 2016.

(30) Foreign Application Priority Data
Dec. 9, 2015 (CN) 201510908328.8

(51) Int. Cl. G06N 5/04; G06N 99/00

(52) U.S. Cl. CPC G06N 5/048; G06N 99/005

(57) ABSTRACT

The embodiment of the present disclosure discloses a recommending method and a recommending device. The recommending method specifically includes the following steps: generating at least one piece of recommended content according to ecological historical behavior data of a user, wherein the ecological historical behavior data of the user include at least one of the following historical behavior data: historical behavior data of the user in at least two applications installed on at least one terminal, and historical behavior data of the user in at least one application installed on at least two terminals; recommending the recommended content to the user.

### CROSS-REFERENCE TO RELATED APPLICATIONS

The present disclosure is a continuation of International Application No. PCT/CN2016/089244, with an international filing date of Jul. 7, 2016, which is based upon and claims priority to Chinese Patent Application No. 201510908328.8, filed on Dec. 9, 2015, and the entire contents of all of which are incorporated herein by reference.

### FIELD OF TECHNOLOGY

The embodiment of the present disclosure generally relates to the technical field of communication, and in particular to a recommending method and an electronic device.

### BACKGROUND

Along with development of intelligent terminals and network techniques, users may play music through various websites, application programs and the like. However, tens of thousands of music resources are provided by various music platforms to users, and finding favorite music from so many music resources is like looking for a needle in a bundle of hay for a user. Therefore, it is necessary to recommend music to the user according to music preference of the user.

A conventional music recommending scheme aims to understand the preference of the user by analyzing historical behavior data of music playing, collection, attention and the like of the user, and then music meeting the preference of the user may be recommended to the user.

However, the conventional music recommending scheme may be brought into play on the basis that the user uses a music platform for a certain time and certain historical behavior data are accumulated. For a new user, as no historical behavior data are available or a relatively few amount of historical behavior data are provided, the preference of the new user cannot be accurately understood according to the historical behavior data by using the conventional music recommending scheme in such circumstance, the accuracy in recommending music to the new user is relatively low, and the recommending effect may be poor.

### SUMMARY

The embodiment of the present disclosure discloses a recommending method and a recommending device, aims to solve the defect that the accuracy in recommending music to a user by using a conventional music recommending scheme is relatively low, and aims to improve the accuracy of recommended content.

An embodiment of the present disclosure discloses a recommending method, including:

generating at least one piece of recommended content according to ecological historical behavior data of a user, wherein the ecological historical behavior data of the user comprise at least one of the following historical behavior data: historical behavior data of the user on at least two applications installed on at least one terminal, and historical behavior data of the user in at least one application installed on at least two terminals;

recommending the recommended content to the user.

An embodiment of the present disclosure discloses an electronic device, including: at least one processor; and a memory communicably connected with the at least one processor for storing instructions executable by the at least one processor, wherein execution of the instructions by the at least one processor causes the at least one processor to:

generate at least one piece of recommended content according to ecological historical behavior data of a user, wherein the ecological historical behavior data of the user comprise at least one of the following historical behavior data: historical behavior data of the user in at least two applications installed on at least one terminal, and historical behavior data of the user in at least one application installed on at least two terminals;

recommend the recommended content to the user.

An embodiment of the present disclosure discloses a computer program, which includes computer readable codes for enabling an intelligent terminal to execute the recommending method above when the computer readable codes are operated on the intelligent terminal.

An embodiment of the present disclosure discloses a non-transitory computer readable medium storing executable instructions that, when executed by an electronic device, cause the electronic device to: generate at least one piece of recommended content according to ecological historical behavior data of a user, wherein the ecological historical behavior data of the user comprise at least one of the following historical behavior data: historical behavior data of the user in at least two applications installed on at least one terminal, and historical behavior data of the user in at least one application installed on at least two terminals; and recommend the recommended content to the user.

### BRIEF DESCRIPTION OF THE DRAWINGS

To clearly describe the technical schemes in the embodiments of the present disclosure or in the prior art, figures need to be used in the description of the embodiments or the prior art are briefly introduced as follows, obviously, the figures described below are some embodiments of the present disclosure, and for a person skilled in the art, other figures may be also obtained according to the figures under the condition that no creative work is made.

FIG. 1 shows the flow chart of steps of the recommending method in some embodiments of the present disclosure.

FIG. 2 shows the flow chart of steps of the recommending method in some embodiments of the present disclosure.

FIG. 3 shows the flow chart of steps of the recommending method in some embodiments of the present disclosure.

FIG. 4 shows the structure schematic diagram of the recommending device in some embodiments of the present disclosure.

FIG. 5 shows the structure schematic diagram of the recommending device in some embodiments of the present disclosure.

FIG. 6 shows the structure schematic diagram of the recommending device in some embodiments of the present disclosure.

FIG. 7 shows the structure schematic diagram of the recommending device in some embodiments of the present disclosure.

FIG. 8 schematically shows the block diagram of an electronic device for executing the methods of some embodiments of the present disclosure.

FIG. 9 schematically shows a storage unit for maintaining or carrying program codes for realizing the recommending method of some embodiments of the present disclosure.

### DETAILED DESCRIPTION

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, other embodiments obtained by a person skilled in the art under the condition that no creative work is made all belong to the protection scope of the present disclosure.

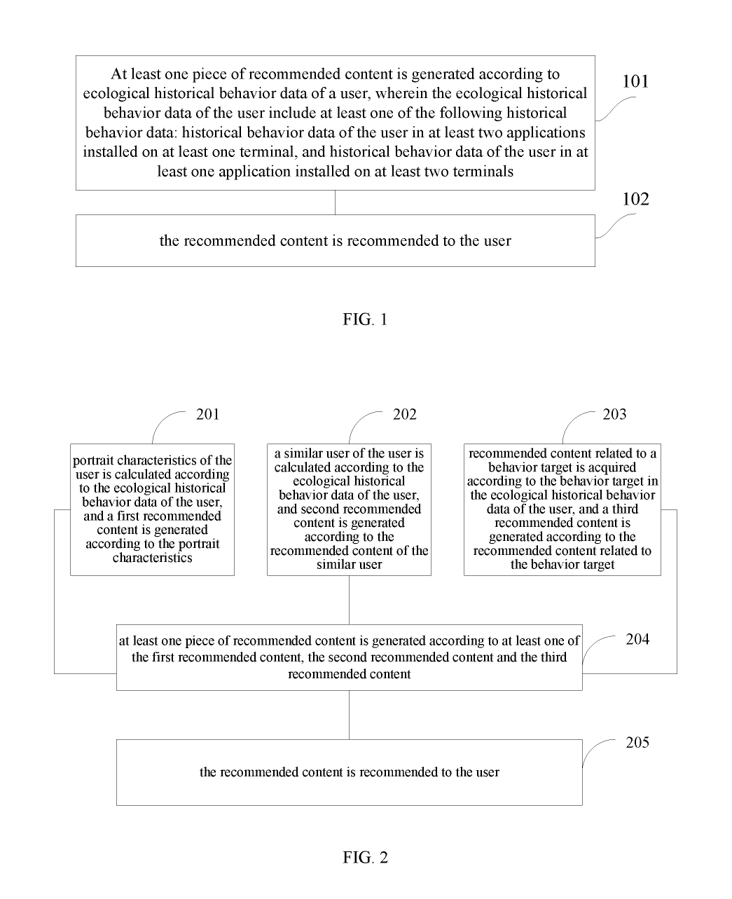

The FIG. 1 shows the flow chart of steps of a recommending method in the embodiment I of the present disclosure, specifically including steps as follows.

In step 101, at least one piece of recommended content is generated according to ecological historical behavior data of a user, wherein the ecological historical behavior data of the user include at least one of the following historical behavior data: historical behavior data of the user in at least two applications installed on at least one terminal, and historical behavior data of the user in at least one application installed on at least two terminals.

The embodiment of the present disclosure may be applied to any application program such as a music software application program and a video software application program of an intelligent terminal, to accurately recommend content such as music and video, which meet preference of the user through the application program.

In the embodiment of the present disclosure, the ecological historical behavior data may be used for presenting operation records generated in the application program of the user, and specifically include the following three situations:

situation 1, historical behavior data of the user on at least two applications installed on one terminal, for example, historical behavior data of the user in a plurality of applications (applications such as a music application, a video application, a wallpaper application, a browser application and a game application) on a mobile phone terminal;

situation 2, historical behavior data of the user in one application installed on at least two terminals, for example, historical behavior data of the user in applications such as the application, the video application, the wallpaper application, the browser application or the game application on a plurality of terminals such as the mobile phone terminal, a tablet computer and an intelligent television;

situation 3, historical behavior data of the user in at least two applications installed on at least two terminals, for example, historical behavior data of the user in applications such as the application, the video application, the wallpaper application, the browser application or the game application on a plurality of terminals such as the mobile phone terminal, the tablet computer and the intelligent television.

In the embodiment of the present disclosure, the ecological historical behavior data may be specifically acquired by: acquiring internet browsing records of the user through a gateway so as to acquire the ecological historical behavior data of the user; and/or acquiring behavior log streams of the user through a third-party application platform so as to acquire the ecological historical behavior data of the user; and/or acquiring the ecological historical behavior data of the user according to data cookies stored in a local terminal of the user, and the modes of acquiring the ecological historical behavior data are not specifically restricted in the embodiment of the present disclosure.

In the embodiment, historical operation of the user in different terminals and different applications may be acquired according to the ecological historical behavior data of the user, the historical operation may be further analyzed so as to obtain the preference of the user, and then recommended content which meets the preference of the user may be acquired according to the preference of the user.

In one optional embodiment of the present disclosure, the method specifically further includes the step of:

determining whether the number of the recommended content is smaller than a first threshold or not, if the number of the recommended content is smaller than the first threshold, acquiring alternate recommended content to supplement the recommended content, wherein the alternate recommended content may be specifically used for representing to public recommended content recommended to all users.

In the embodiment of the present disclosure, if the number of the recommended content generated according to the ecological historical behavior data is smaller than the first threshold, the alternate recommended content may be acquired to supplement the recommended content, and the alternate recommended content may be the public recommended content which is created by an application background operator and/or automatically generated by one application according to a click rate and is recommended to all users, and specifically includes: recommended content such as recommended content with a tag of hot, recommended content with a tag of new and recommended content with a tag of one area.

In one optional embodiment of the present disclosure, the method specifically further includes the following steps:

a recommending reason of the recommended content is recommended to the user, for example, the corresponding recommending reason of recommended content “Song of the wind god” is “the user watched the movie “Red Sorghum””.

In step 102, the recommended content is recommended to the user.

To sum up, by adopting the recommending method provided by the embodiment of the present disclosure, the recommended content may be generated according to the ecological historical behavior data of the user, the ecological historical behavior data specifically include: historical behavior data of the user in at least two applications installed on at least one terminal, and historical behavior data of the user in at least one application installed on at least two terminals. Compared with the conventional recommending scheme that preference of the user is understood by analyzing historical behavior data of music play, collection, attention and the like of the user so as to recommend music meeting the preference of the user to the user, the embodiment of the present disclosure is relatively rich in ecological historical behavior data and relatively precise in analysis result of the preference of the user on the basis of the rich ecological historical behavior data as the ecological historical behavior data may be acquired from multiple terminals and multiple applications, and thus the accuracy of the recommended content may be improved. When the user is a new user, music may be recommended according to historical behavior data of the user in a third-party application program or other terminals, so that the problem that the recommending accuracy is low when the historical behavior data of the new user in application programs are not available or only a relatively few amount of historical behavior data may be obtained may be solved.

FIG. 2 shows the flow chart of steps of a recommending method in the embodiment II of the present disclosure, specifically including steps as follows:

in step 201, portrait characteristics of the user is calculated according to the ecological historical behavior data of the user, and a first recommended content is generated according to the portrait characteristics; and/or

in step 202, a similar user of the user is calculated according to the ecological historical behavior data of the user, and second recommended content is generated according to the recommended content of the similar user; and/or

in step 203, recommended content related to a behavior target is acquired according to the behavior target in the ecological historical behavior data of the user, and a third recommended content is generated according to the recommended content related to the behavior target;

in step 204, at least one piece of recommended content is generated according to at least one of the first recommended content, the second recommended content and the third recommended content;

in step 205, the recommended content is recommended to the user.

Compared with the method in the embodiment I, the method of the embodiment aims to refine the step of generating the recommended content according to the ecological historical behavior data of the user through the steps 201 to 204, analyze the ecological historical behavior data of the user so as to acquire the third recommended content, calculate the portrait characteristics of the user and the similar user of the user so as to generate the first recommended content and the second recommended content, and thereby generating the recommended content according to the first recommended content, the second recommended content and the third recommended content.

In the step 201, the ecological historical behavior data of the user may be analyzed and the portrait characteristics of the user may be calculated, then the first recommended content may be generated according to the portrait characteristics.

The portrait characteristics of the user may be specifically a tag set for depicting characteristics of the user, for example, basic attributes such as age, gender and region, or interest characteristics of the user, for example, attributes such as a language tag of playing music and a type tag of the playing music.

In one application example of the present disclosure, assume that the analysis on the ecological historical behavior data of the user shows that the obtained portrait characteristics of the user specifically include: female, 24 years old, the language tag of the playing music is Europe and America, and the type tag of the playing music is an anime interlude song and the like, the recommended content acquired according to the portrait characteristics of the user may specifically include: hot songs popular with young females, music with the tag of Europe and America, music with the tag of anime, and the like.

In the step 202, the ecological historical behavior data of the user may be analyzed and the similar user of the user may be calculated, and then recommended content of the similar user may be acquired and the second recommended content may be generated.

In the embodiment of the present disclosure, the similar user of the user may be a user with interests and hobbies same as those of a current user, specifically may be a similar user calculated by using a user-based algorithm, of the current user, the specific process may be: acquiring interest characteristics of the current user according to the ecological historical behavior data of the user, wherein the interest characteristics may specifically include operation characteristics of the user to a historical behavior target, for example, the user enjoys, and/or searches, and/or clicks, and/or pays attention to, and/or collect one piece of historical content; establishing an interest characteristic vector of the user by taking the interest characteristics as dimensions, calculating the similarity of other users and the current user by using the interest characteristic vector, confirming a user of which the similarity is greater than the first threshold as the similar user of the current user, and generating the second recommended content according to the recommended content of the similar user of the current user.

In one application example of the present disclosure, assume that an interest characteristic vector 1 is established according to ecological historical behavior data of a user A, and an interest characteristic vector i of other users different from the current user may be acquired, wherein i may be an identifier of other users different from the current user; a cosine value of the interest characteristic vector i and the interest characteristic vector 1 may be calculated so as to confirm that the cosine value is just the similarity of the current user, a similar user confirmed according to the similarity, of the user A is just a user B or a user D recommended content 1 of the user B and recommended content 2 of the user D may be acquired, and the recommended content 1 and the recommended content 2 may be combined as the recommended content.

In the step 203, recommended content related to the behavior target may be acquired according to the behavior target in the ecological historical behavior data of the user, and the third recommended content may be generated according to the recommended content related to the behavior target.

In one application example of the present disclosure, assume that a user watches a movie named as “Red Sorghum” by using video play software, the behavior target of the historical behavior target may be the “Red Sorghum”, music related to the “Red Sorghum” such as the “Song of the wind god” and the “Girl, just go ahead!” may be acquired, related singers, composers or other music albums may be found according to the interlude songs and the like, then more related music may be acquired, and the third recommended content may be generated according to the music.

In another application example of the present disclosure, a user reads a novel Soldiers Sortie by using electronic book software, TV dramas adapted from the novel of the same name may be acquired according to the novel name Soldiers Sortie recorded in ecological historical behavior data, furthermore opening songs, ending songs and interlude songs of the TV dramas may be found, or even other movies and television plays of same actors may be found, related music may be acquired, and the third recommended content may be generated according to the music.

In another application example of the present disclosure, after a user browses websites by using browser software, a plurality of URL (Uniform Resource Locator) historical records may be made, then background music of corresponding web pages may be acquired as related music according to URLs recorded in ecological historical behavior data of the websites, and the third recommended content may be generated according to the music.

In another application example of the present disclosure, a user operates game software, then related background music in a game may be acquired according to the name of the game recorded in ecological historical behavior data, even background music of anima adapted from the game of the same name may be acquired, and the third recommended content may be generated according to the music.

The modes of acquiring related recommended content according to ecological historical behavior data are schematically enumerated above. In the embodiments of the present disclosure, content recorded in ecological historical behavior data and modes for acquiring related music may be both determined according to specific situations, and the embodiments of the present disclosure do not restrict the ecological historical behavior data and the modes for acquiring the related music.

What needs to be described is that before the recommended content is generated according to the ecological historical behavior data of the user, the ecological historical behavior data of the user may be also filtered to move off ecological historical behavior data, which do not meet the preference of the user. For example, if the time of the user watching one movie is too short (3 minutes) in the ecological historical behavior data, it may be deemed that the user does not like the movie, then the movie may be filtered, and it may be understood that specific filtering rules are not restricted in the embodiments of the present disclosure.

In the practical application, the step that at least one piece of recommended content is generated according to at least one of the first recommended content, the second recommended content and the third recommended content may specifically include: confirming the first recommended content, the second recommended content or the third recommended content as the recommended content, or combing any of the three pieces of recommended content to generate the recommended content.

In one optional embodiment of the present disclosure, the step of generating at least one piece of recommended content according to at least one of the first recommended content, the second recommended content and the third recommended content may specifically include:

the first recommended content, and/or the second recommended content, and/or the third recommended content is selected in a preset ratio to obtain at least one piece of the recommended content.

In one application example 1 of the present disclosure, assume that a first preset ratio in the embodiment of the present disclosure is 20%, a second preset ratio is 20% and a third preset ratio is 60%, the embodiment of the present disclosure may be specifically: acquiring the recommended content of the first recommended content in a ratio of 20%, acquiring the recommended content of the second recommended content in a ratio of 20%, acquiring the recommended content of the third recommended content in a ratio of 60%, and combining the three pieces of acquired recommended content so as to obtain the recommended content;

In one application example 2 of the present disclosure, assume that the first preset ratio in the embodiment of the present disclosure is 20% and the second preset ratio is 80%, the embodiment of the present disclosure may be specifically: acquiring the recommended content of the first recommended content in a ratio of 20%, acquiring the recommended content of the second recommended content in a ratio of 80%, if the numbers of the two pieces of recommended content are not sufficient, supplementing by using the third recommended content.

In one optional embodiment of the present disclosure, the preset ratio may be determined by a technician of the field according to practical application demands, for example, if the technician of the field deems that the accuracy of the first recommended content is relatively high, the ratio corresponding to the first recommended content may be set to be relatively high.

In another optional embodiment of the present disclosure, the preset ratio may be also determined according to behavior data of the user to the recommended content, for example, counting browsing behavior or listening behavior of the user to the recommended content of the first recommended content, the second recommended content and the third recommended content respectively, confirming the ratios of the recommended content of the first recommended content, the second recommended content and the third recommended content to total recommended content browsed or listened by the user respectively according to counting results, and taking the ratios as current preset ratios.

It may be understood that a mode I that the technician of the field confirms the preset ratios according to practical application demands and a mode II that the preset ratios are confirmed according to behavior data of the user to the recommended content may be combined to use, for example, at the beginning, the preset ratios may be confirmed in the mode I, along with accumulation of the behavior data of the user to the recommended content, the preset ratios may be continuously adjusted in the mode II, and it may be understood that specific preset ratio confirming modes are not restricted in the embodiments of the present disclosure.

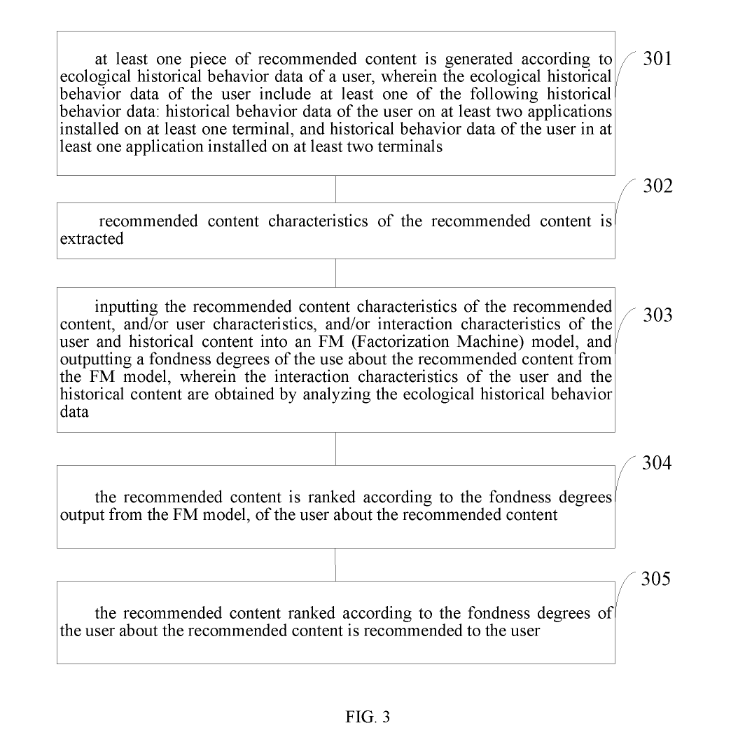

FIG. 3 shows the flow chart of steps of the recommending method in the embodiment III of the present disclosure, specifically including:

in step 301, at least one piece of recommended content is generated according to ecological historical behavior data of a user, wherein the ecological historical behavior data of the user include at least one of the following historical behavior data: historical behavior data of the user on at least two applications installed on at least one terminal, and historical behavior data of the user in at least one application installed on at least two terminals;

in step 302, recommended content characteristics of the recommended content is extracted;

in step 303, inputting the recommended content characteristics of the recommended content, and/or user characteristics, and/or interaction characteristics of the user and historical content into an FM (Factorization Machine) model, and outputting a fondness degrees of the use about the recommended content from the FM model, wherein the interaction characteristics of the user and the historical content are obtained by analyzing the ecological historical behavior data;

in step 304, the recommended content is ranked according to the fondness degrees output from the FM model, of the user about the recommended content;

in step 305, the recommended content ranked according to the fondness degrees of the user about the recommended content is recommended to the user.

Relative to the embodiment I of the method, steps 302 to 304 are added in the embodiment of the present disclosure, that is, the recommended content is ranked according to the fondness degrees of the user, and the ranked recommended content is recommended to the user in the step 305, so that recommended content which best meets the preference of the user may be ranked at a first place, and better experience may be provided to the user.

In the embodiment of the present disclosure, the recommended content characteristics may specifically include various attributes such as the tag of the recommended content (for example, attributes such as the generation after 90s, rock and Europe and America), for example, for a song named as “Nunchakus”, the recommended content characteristics may specifically include characteristics of the generation after 90s, hip pop, Chinese style, the mainland and the like; the user characteristics may specifically include the portrait characteristics of the user and the like; the interaction characteristics of the user and the historical content may specifically include operation such as clicking, and/or collection, and/or attention with a red heart of the user about the historical content.

In the embodiment of the present disclosure, the recommended content characteristics of the recommended content, and/or the user characteristics, and/or the interaction characteristics of the user and the historical content may be input into the FM (Factorization Machine) model, the FM model calculates according to a plurality of vector dimensions and outputs the fondness degrees of the user about the recommended content, the fondness degrees of the user about the recommended content are compared, and furthermore the recommended content may be ranked in a sequence of the fondness degrees of the user about the recommended content from large to small.

In one optional embodiment of the present disclosure, the FM model may be specifically:

$$y ( x ) = y ( u , i , d ) = {w}_{0} + {w}_{u} ( u ) + {w}_{i} ( i ) + {\sum }_{d ∈ D} {w}_{d} ( d ) + {\sum }_{f = 1}^{k} {v}_{u , f} {v}_{i , f} ( u , i ) + {\sum }_{f = 1}^{k} {v}_{u , f} {\sum }_{d ∈ D} {v}_{d , f} ( u , d ) + {\sum }_{f = 1}^{k} {v}_{i , f} {\sum }_{d ∈ D} {v}_{d , f} ( i , d )$$

In the formula, u may represent an identifier of a current user, i may represent an identifier of current recommended content, d may represent comprehensive characteristics, the comprehensive characteristics may specifically include at least one of the following characteristics: user characteristics, historical content characteristics (recommended content characteristics) and interaction characteristics of the user and the historical content, u, i and d may be independent variables joining in calculation of the FM model, y may represent a prediction result, that is, the fondness degrees of the current user about the recommended content, x may represent a training sample (recommended content), W₀ may represent a global offset factor, W_{u may} represent a user characteristic offset factor, Wᵢ may represent a recommended content characteristic offset factor, W_{d} may represent a comprehensive parameter factor, V_{u,f} and V_{i,f} may represent an interaction factor of the user and the recommended content, and V_{u,f} and V_{d,f} may represent an interaction factor of the user and the comprehensive characteristics.

In one optional embodiment of the present disclosure, the embodiment of the present disclosure may specifically include the following steps to train the FM model:

in S1, comprehensive characteristics is extracted from the ecological historical behavior data of the user, wherein the comprehensive characteristics include at least one of the following characteristics: the user characteristics, the historical content characteristics and the interaction characteristics of the user and the historical content;

in S2, the comprehensive characteristics is fused into the FM model, thereby training the FM model.

In the embodiment of the present disclosure, the historical content characteristics may be characteristics of historical content acquired from the ecological historical behavior data, and the historical content represents content operated by the user and specifically includes content, which is enjoyed, and/or searched, and/or clicked, and/or paid attention to, and/or collected by the user.

In the embodiment of the present disclosure, the comprehensive characteristics extracted from the ecological historical behavior data of the user are adopted to train the FM model to obtain a model equation for predicting the fondness degrees of the user about the recommended content according to the preference of the user.

Comprehensively, by adopting the recommending method provided by the embodiments of the present disclosure, the comprehensive characteristics extracted from the ecological historical behavior data of the user may be adopted to train the FM model, then the recommended content generated according to the ecological historical behavior data may be ranked by using the trained FM model in the embodiment of the present disclosure, and thus recommended content in an optimal sequence may be acquired and recommended to the user. As the FM model in the embodiment of the present disclosure may predict the fondness degrees of the user about the recommended content according to a plurality of characteristic vectors such as the user characteristics and the interaction characteristics of the user and the historical content acquired by analyzing the ecological historical behavior data, and the recommended content characteristics acquired by analyzing the recommended content, that is, on the basis of the plurality of vector dimensions, the fondness degrees of the user about the recommended content may be relatively precisely predicted, and an optimal ranking result may be obtained when the recommended content is ranked according to the fondness degrees.

What needs to be explained is that to be described concisely, the method in the embodiments is expressed as a combination of a series of action, however the technician of the field shall understand that the embodiment of the present disclosure is not restricted by the sequence of the described action as some steps may be implemented in other sequences or simultaneously in the embodiments of the present disclosure. Secondly, the technician of the field shall also understand that the embodiments in the present disclosure are all optional embodiments, and action involved in the embodiments is not definitely essential in the embodiments of the present disclosure.

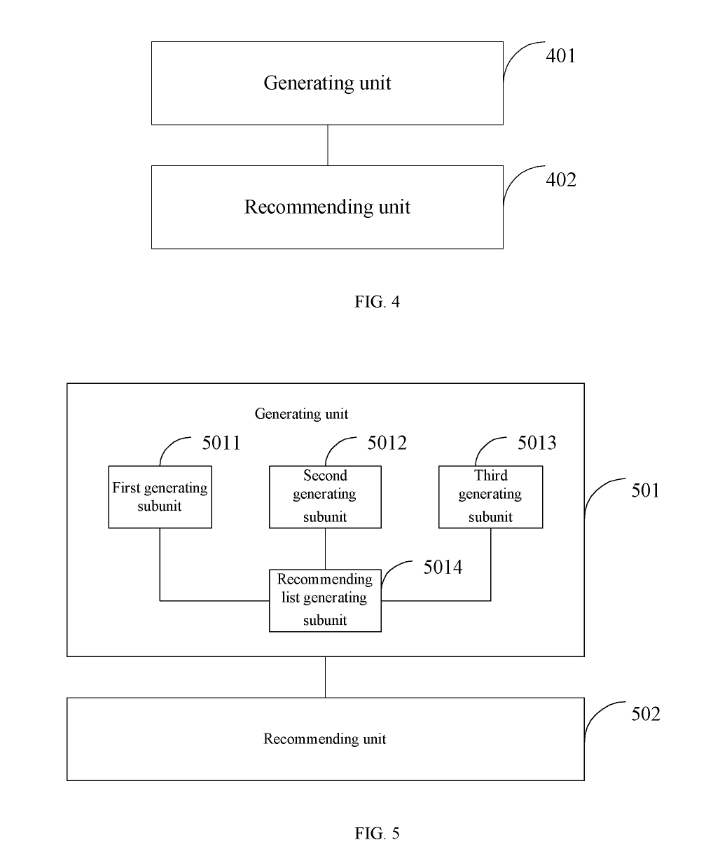

FIG. 4 shows the structure schematic diagram of a recommending device in the embodiment I of the present disclosure, specifically including a generating unit 401 and a recommending unit 402, wherein:

the generating unit 401 is used for generating at least one piece of recommended content according to ecological historical behavior data of a user, wherein the ecological historical behavior data of the user include at least one of the following historical behavior data: historical behavior data of the user in at least two applications installed on at least one terminal, and historical behavior data of the user in at least one application installed in at least two terminals;

the recommending unit 402 is used for recommending the recommended content to the user.

In one optimal embodiment of the present disclosure, the recommending device may specifically further include:

an alternate unit for determining whether the number of the recommended content is smaller than a first threshold or not, if the number of the recommended content is smaller than the first threshold, acquiring alternate recommended content to supplement the recommended content, wherein the alternate recommended content refers to public recommended content recommended to all users.

In one optimal embodiment of the present disclosure, the embodiment of the present disclosure may specifically further include:

a recommending reason unit for recommending a recommending reason of the recommended content to the user.

FIG. 5 shows the structure schematic diagram of the recommending device in the embodiment II of the present disclosure, specifically including a generating unit 501 and a recommending unit 502, wherein:

the generating unit 501 is used for generating at least one piece of recommended content according to ecological historical behavior data of a user, wherein the ecological historical behavior data of the user include at least one of the following historical behavior data: historical behavior data of the user in at least two applications installed on at least one terminal, and historical behavior data of the user in at least one application installed in at least two terminals;

the recommending unit 502 is used for recommending the recommended content to the user;

wherein the generating unit 501 may specifically include:

a first generating subunit 5011 for calculating portrait characteristics of the user according to the ecological historical behavior data of the user, and generating first recommended content according to the portrait characteristics; and/or

a second generating subunit 5012 for calculating a similar user of the user according to the ecological historical behavior data of the user, and generating second recommended content according to the recommended content of the similar user; and/or

a third generating subunit 5013 for acquiring recommended content related to a behavior target according to the behavior target in the ecological historical behavior data of the user, and for generating third recommended content according to the recommended content related to the behavior target;

a generating subunit 5014 for generating at least one piece of recommended content according to at least one of the first recommended content, the second recommended content and the third recommended content.

In one optional embodiment of the present disclosure, the recommended content generating subunit 5014 may specifically include:

an acquiring module for selecting the first recommended content, and/or the second recommended content, and/or the third recommended content according to a preset ratio, thereby obtaining at least one recommended content.

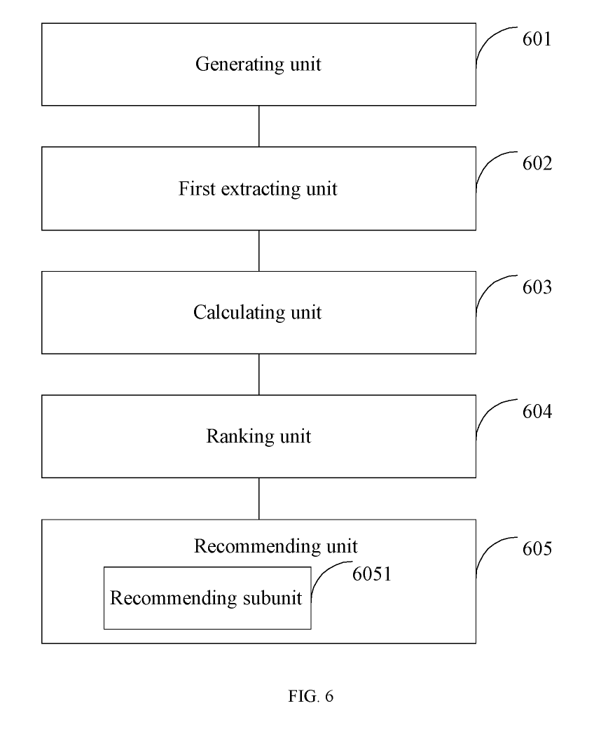

FIG. 6 shows the structure schematic diagram of the recommending device in the embodiment III of the present disclosure, specifically including a generating unit 601, a first extracting unit 602, a calculating unit 603, a ranking unit 604 and a recommending unit 605, wherein:

the generating unit 601 is used for generating at least one piece of recommended content according to ecological historical behavior data of a user, wherein the ecological historical behavior data of the user include at least one of the following historical behavior data: historical behavior data of the user in at least two applications installed on at least one terminal, and historical behavior data of the user in at least one application installed in at least two terminals;

the first extracting unit 602 is used for extracting recommended content characteristics of the recommended content;

the calculating unit 603 is used for inputting the recommended content characteristics of the recommended content, and/or user characteristics, and/or interaction characteristics of the user and historical content into an FM (Factorization Machine) model, and outputting a fondness degrees of the use about the recommended content from the FM model, wherein the interaction characteristics of the user and the historical content are obtained by analyzing the ecological historical behavior data;

the a ranking unit 604 is used for ranking the recommended content according to the fondness degrees output from the FM model, of the user about the recommended content;

the recommending unit 605 is used for recommending the recommended content to the user;

then the recommending unit 605 may specifically further include:

a recommending subunit 6051 for recommending the recommended content ranked according to the fondness degrees of the user about the recommended content to the user.

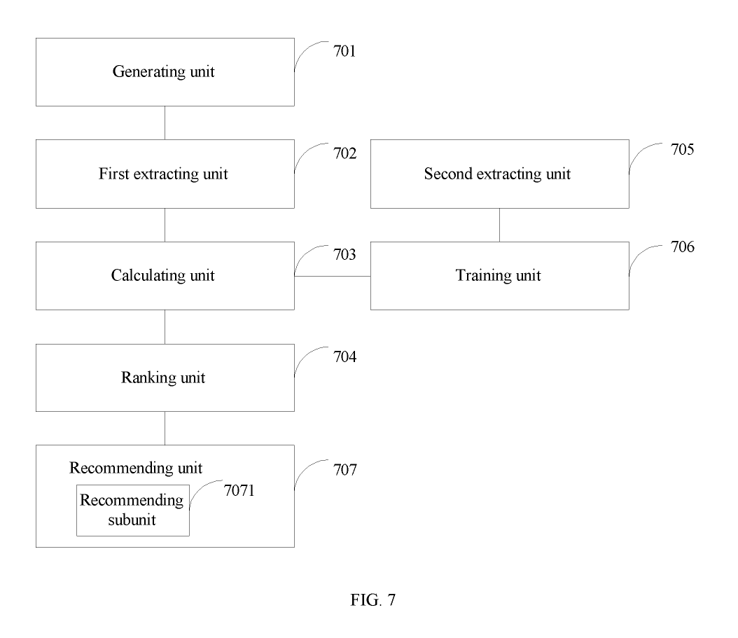

FIG. 7 shows the structure schematic diagram of the recommending device in the embodiment IV of the present disclosure, specifically including: a generating unit 701, a first extracting unit 702, a calculating unit 703, a ranking unit 704, a second extracting unit 705, a training unit 706 and a recommending unit 707, wherein:

the generating unit 701 is used for generating at least one piece of recommended content according to ecological historical behavior data of a user, wherein the ecological historical behavior data of the user include at least one of the following historical behavior data: historical behavior data of the user in at least two applications installed on at least one terminal, and historical behavior data of the user in at least one application installed in at least two terminals;

the first extracting unit 702 is used for extracting recommended content characteristics of the recommended content;

the calculating unit 703 is used for inputting the recommended content characteristics of the recommended content, and/or user characteristics, and/or interaction characteristics of the user and historical content into an FM (Factorization Machine) model, and outputting a fondness degrees of the use about the recommended content from the FM model, wherein the interaction characteristics of the user and the historical content are obtained by analyzing the ecological historical behavior data;

the ranking unit 704 is used for ranking the recommended content according to the fondness degrees output from the FM model, of the user about the recommended content;

the second extracting unit 705 is used for extracting comprehensive characteristics from the ecological historical behavior data of the user, wherein the comprehensive characteristics include at least one of the following characteristics: the user characteristics, the historical content characteristics and the interaction characteristics of the user and the historical content;

the training unit 706 is used for fusing the comprehensive characteristics into the FM model, thereby training the FM model;

the recommending unit 707 is used for recommending the recommended content to the user;

then the recommending unit 707 may specifically include:

a recommending subunit 7071 for recommending the recommended content ranked according to the fondness degrees of the user about the recommended content to the user.

As the device of the embodiments is generally similar to the method of the embodiments, the device is relatively concisely described, see related parts in description of the method of the embodiments.

The embodiments of the device described above are only schematic, a unit which may be described as a separated part may be or not physically separated, a member for unit display may be or not a physical unit, that is, the member may be located at one place or distributed to multiple network units. A part of or all modules may be selected to achieve the purposes of the schemes of the embodiments according to practical demands. The present disclosure may be understood and implemented by a person skilled in the art without creative work.

On the basis of the description of the embodiments, a person skilled in the art may clearly understand that the embodiments may be achieved through software together with essential universal hardware platforms, and may definitely achieved through hardware. Based on the understanding, the technical scheme or the part contributing to the prior art may be embodied in a software product mode, the computer software product may be stored in computer readable storage mediums such as ROM/RAM, magnetic discs and optical discs with a plurality of instructions for enabling computer equipment (a personal computer, a server, network equipment and the like) to execute the embodiments or the methods described in some of the embodiments.

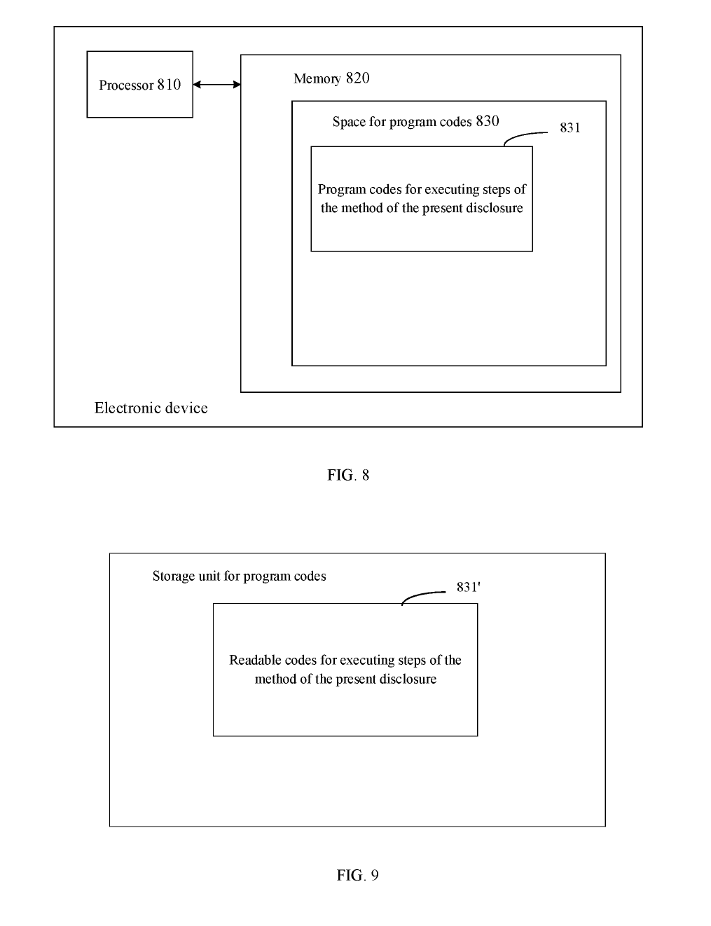

For example, FIG. 8 illustrates a block diagram of an electronic device for executing the method according the disclosure. The electronic device may be the intelligent terminal above. Traditionally, the electronic device includes a processor 810 and a computer program product or a computer readable medium in form of a memory 820. The memory 820 could be electronic memories such as flash memory, EEPROM (Electrically Erasable Programmable Read-Only Memory), EPROM, hard disk or ROM. The memory 820 has a memory space 830 for executing program codes 831 of any steps in the above methods. For example, the memory space 830 for program codes may include respective program codes 831 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 9. The memory cells may be provided with memory sections, memory spaces, etc., similar to the memory 820 of the electronic device as shown in FIG. 8. The program codes may be compressed for example in an appropriate form. Usually, the memory cell includes computer readable codes 831′ which may be read for example by processors 810. When these codes are operated on the electronic device, the electronic device may execute respective steps in the method as described above.

The final description is that the embodiments are only used for describing the technical scheme of the present disclosure but not for limiting. Although the present disclosure is specifically described with reference to the embodiments, a person skilled in the art shall understand that the technical scheme recorded by each of the embodiments may be modified, or one part of technical characteristics may be equivalently replaced; and the modification or replacement does not enable the essence of the corresponding technical scheme to get out of the spirit and scope of the technical scheme in each embodiment of the present disclosure.

What is claimed is:

1. A recommending method, comprising:
generating at least one piece of recommended content according to ecological historical behavior data of a user, wherein the ecological historical behavior data of the user comprise at least one of the following historical behavior data: historical behavior data of the user in at least two applications installed on at least one terminal, and historical behavior data of the user in at least one application installed on at least two terminals;
recommending the recommended content to the user.

2. The recommending method according to the claim 1, wherein the generating at least one piece of recommended content according to ecological historical behavior data of the user comprises:
calculating portrait characteristics of the user according to the ecological historical behavior data of the user, and generating first recommended content according to the portrait characteristics; or
calculating a similar user of the user according to the ecological historical behavior data of the user, and generating second recommended content according to the recommended content of the similar user; or
acquiring recommended content related to a behavior target according to the behavior target in the ecological historical behavior data of the user, and generating third recommended content according to the recommended content related to the behavior target;
generating at least one piece of recommended content according to at least one of the first recommended content, the second recommended content and the third recommended content.

3. The recommending method according to the claim 1, further comprising:
extracting recommended content characteristics of the recommended content;
inputting the recommended content characteristics of the recommended content, or user characteristics, or interaction characteristics of the user and historical content into an FM model, and outputting fondness degrees of the use about the recommended content from the FM model, wherein the interaction characteristics of the user and the historical content are obtained by analyzing the ecological historical behavior data;
ranking the recommended content according to the fondness degrees output from the FM model, of the user about the recommended content;
then the step of recommending the recommended content to the user comprises:
recommending the recommended content ranked according to the fondness degrees of the user about the recommended content to the user.

4. The recommending method according to the claim 3, further comprising:
extracting comprehensive characteristics from the ecological historical behavior data of the user, wherein the comprehensive characteristics comprise at least one of the following characteristics: the user characteristics, the historical content characteristics and the interaction characteristics of the user and the historical content;
fusing the comprehensive characteristics into the FM model to obtain the FM model.

5. The recommending method according to the claim 2, wherein the generating at least one piece of recommended content according to at least one of the first recommended content, the second recommended content and the third recommended content comprises:
selecting the first recommended content, or the second recommended content, or the third recommended content according to a preset ratio to obtain at least one recommended content.

6. The recommending method according to the claim 1, further comprising:
determining whether the number of the recommended content is smaller than a first threshold or not, if the number of the recommended content is smaller than the first threshold, acquiring alternate recommended content to supplement, wherein the alternate recommended content refers to public recommended content recommended to all users.

7. The recommending method according to the claim 1, further comprising:
recommending a recommending reason of the recommended content to the user.

8. An electronic device, comprising:
at least one processor; and
a memory communicably connected with the at least one processor for storing instructions executable by the at least one processor, wherein execution of the instructions by the at least one processor causes the at least one processor to:
generate at least one piece of recommended content according to ecological historical behavior data of a user, wherein the ecological historical behavior data of the user comprise at least one of the following historical behavior data: historical behavior data of the user in at least two applications installed on at least one terminal, and historical behavior data of the user in at least one application installed on at least two terminals;
recommend the recommended content to the user.

9. The electronic device according to the claim 8, wherein the step to generate at least one piece of recommended content according to ecological historical behavior data of the user comprises:
calculating portrait characteristics of the user according to the ecological historical behavior data of the user, and generate first recommended content according to the portrait characteristics; or
calculating a similar user of the user according to the ecological historical behavior data of the user, and generate second recommended content according to the recommended content of the similar user; or
acquiring recommended content related to a behavior target according to the behavior target in the ecological historical behavior data of the user, and generate third recommended content according to the recommended content related to the behavior target;
generating at least one piece of recommended content according to at least one of the first recommended content, the second recommended content and the third recommended content.

10. The electronic device according to the claim 8, wherein execution of the instructions by the at least one processor further causes the at least one processor to:
extract recommended content characteristics of the recommended content;
input the recommended content characteristics of the recommended content, or user characteristics, or interaction characteristics of the user and historical content into an FM model, and outputting fondness degrees of the use about the recommended content from the FM model, wherein the interaction characteristics of the user and the historical content are obtained by analyzing the ecological historical behavior data;
rank the recommended content according to the fondness degrees output from the FM model, of the user about the recommended content;
recommend the recommended content to the user comprises:
recommend the recommended content ranked according to the fondness degrees of the user about the recommended content to the user.

11. The electronic device according to the claim 10, wherein execution of the instructions by the at least one processor further causes the at least one processor to:
extract comprehensive characteristics from the ecological historical behavior data of the user, wherein the comprehensive characteristics comprise at least one of the following characteristics: the user characteristics, the historical content characteristics and the interaction characteristics of the user and the historical content;
fuse the comprehensive characteristics into the FM model to train the FM model.

12. The electronic device according to the claim 9, wherein generate at least one piece of recommended content according to at least one of the first recommended content, the second recommended content and the third recommended content comprises:
select the first recommended content, or the second recommended content, or the third recommended content according to a preset ratio to obtain at least one recommended content.

13. The electronic device according to the claim 8, wherein execution of the instructions by the at least one processor causes the at least one processor to further:
determine whether the number of the recommended content is smaller than a first threshold or not, if the number of the recommended content is smaller than the first threshold, acquire alternate recommended content to supplement, wherein the alternate recommended content refers to public recommended content recommended to all users.

14. The electronic device according to the claim 8, wherein execution of the instructions by the at least one processor causes the at least one processor to further:
recommend the recommending reason of the recommended content to the user.

15. A non-transitory computer readable medium storing executable instructions that, when executed by an electronic device, cause the electronic device to:
generate at least one piece of recommended content according to ecological historical behavior data of a user, wherein the ecological historical behavior data of the user comprise at least one of the following historical behavior data: historical behavior data of the user in at least two applications installed on at least one terminal, and historical behavior data of the user in at least one application installed on at least two terminals;
recommend the recommended content to the user.

16. The non-transitory computer readable medium according to the claim 15, wherein the generating at least one piece of recommended content according to ecological historical behavior data of the user comprises:
calculating portrait characteristics of the user according to the ecological historical behavior data of the user, and generate first recommended content according to the portrait characteristics; or
calculating a similar user of the user according to the ecological historical behavior data of the user, and generate second recommended content according to the recommended content of the similar user; or
acquiring recommended content related to a behavior target according to the behavior target in the ecological historical behavior data of the user, and generate third recommended content according to the recommended content related to the behavior target;
generating at least one piece of recommended content according to at least one of the first recommended content, the second recommended content and the third recommended content.

17. The non-transitory computer readable medium according to the claim 15, wherein the electronic device is further caused to:
extract recommended content characteristics of the recommended content;
input the recommended content characteristics of the recommended content, or user characteristics, or interaction characteristics of the user and historical content into an FM model, and outputting fondness degrees of the use about the recommended content from the FM model, wherein the interaction characteristics of the user and the historical content are obtained by analyzing the ecological historical behavior data;
rank the recommended content according to the fondness degrees output from the FM model, of the user about the recommended content;
the step to recommend the recommended content to the user comprises:
recommend the recommended content ranked according to the fondness degrees of the user about the recommended content to the user.

18. The non-transitory computer readable medium according to the claim 16, wherein the step to generate at least one piece of recommended content according to at least one of the first recommended content, the second recommended content and the third recommended content comprises:
selecting the first recommended content, or the second recommended content, or the third recommended content according to a preset ratio to obtain at least one recommended content.

19. The non-transitory computer readable medium according to the claim 15, wherein the electronic device is further caused to:
determine whether the number of the recommended content is smaller than a first threshold or not, if the number of the recommended content is smaller than the first threshold, acquire alternate recommended content to supplement, wherein the alternate recommended content refers to public recommended content recommended to all users.

20. The non-transitory computer readable medium according to the claim 15, wherein the electronic device is further caused to:
recommend the recommending reason of the recommended content to the user.
